(19) United States
(12) Patent Application Publication
(10) Pub. No.: US 2026/0099318 A1
(43) Pub. Date: Apr. 9, 2026

(54) ELECTRONIC DEVICE

(71) Applicant: SEIKO EPSON CORPORATION, TOKYO (JP)

(72) Inventors: Norihiko NAKAJIMA, MATSUMOTO-SHI (JP); Aya TAKIO, SHIOJIRI-SHI (JP); Daiki ITO, MATSUMOTO-SHI (JP)

(21) Appl. No.: 19/353,652

(22) Filed: Oct. 9, 2025

(30) Foreign Application Priority Data
Oct. 9, 2024 (JP) 2024-176946

(51) Int. Cl. G06F 8/65; G06F 11/14; H04W 76/14

(52) U.S. Cl. CPC G06F 8/65; G06F 11/1433; H04W 76/14

(57) ABSTRACT

An electronic device includes an update retry control unit that, when update processing of firmware is abnormally terminated, permits a retry of the update processing by performing communication with a first terminal device by a first communication method and prohibits a retry of the update processing by performing communication with a second terminal device by a second communication method, when it is recognized that the situation is a first situation, and that permits a retry of the update processing by performing communication with the first terminal device by the first communication method and a retry of the update processing by performing communication with the second terminal device by the second communication method, when it is recognized that the situation is a second situation different from the first situation.

The present application is based on, and claims priority from JP Application Serial Number 2024-176946, filed October 9, 2024, the disclosure of which is hereby incorporated by reference herein in its entirety.

### BACKGROUND

### 1. Technical Field

The present disclosure relates to an electronic device that performs update processing of firmware.

### 2. Related Art

According to the related art, for a printing system having a communication function based on two types of communication methods, a technique in which, when an update of firmware using communication by one communication method fails, a recovery operation is performed using the other communication method, is known (for example, refer to JP-A-2023-130149). JP-A-2023-130149 discloses a configuration in which, in a recovery operation when an update of firmware using network communication fails, a function restriction is performed so as to execute only communication by USB (registered trademark) without executing network communication.

JP-A-2023-130149 is an example of the related art.

In the configuration described in JP-A-2023-130149, when a recovery is performed as the update of firmware fails, network communication of the two types of communication methods cannot be used and therefore a user needs to prepare a terminal device such as a personal computer that can be connected via USB and then perform the recovery. When such a terminal device cannot be prepared, the recovery cannot be performed.

### SUMMARY

According to an aspect of the present disclosure, an electronic device includes: a firmware update unit configured to execute update processing of firmware saved in a storage unit, using update data acquired by performing communication with a first terminal device by a first communication method or by performing communication with a second terminal device by a second communication method; a situation recognition unit configured to recognize, when an abnormal termination of the update processing occurs, an abnormal termination situation, which is a situation of when the abnormal termination occurs; and an update retry control unit configured to permit a retry of the update processing by performing communication with the first terminal device by the first communication method and prohibit a retry of the update processing by performing communication with the second terminal device by the second communication method, when the situation recognition unit recognizes that the abnormal termination situation is a first situation as the abnormal termination of the update processing occurs, and to permit a retry of the update processing by performing communication with the first terminal device by the first communication method and a retry of the update processing by performing communication with the second terminal device by the second communication method, when the situation recognition unit recognizes that the abnormal termination situation is a second situation different from the first situation.

### BRIEF DESCRIPTION OF THE DRAWINGS

FIG. 1 shows the configuration of a printing device according to an embodiment.

FIG. 2 illustrates flash ROM mapping.

FIG. 3 is a flowchart of update processing of firmware.

### DESCRIPTION OF EMBODIMENTS

### 1. Configuration of Printing Device

The present embodiment will now be described with reference to the drawings.

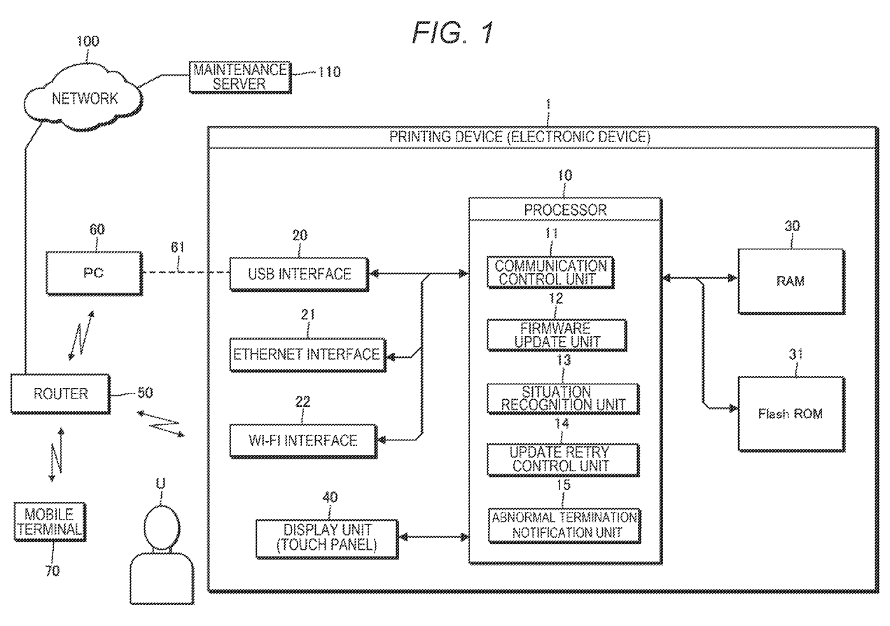

FIG. 1 shows the configuration of a printing device 1 according to the present embodiment. The printing device 1 corresponds to an electronic device according to the present disclosure.

The printing device 1 has a communication function based on each of USB (registered trademark), Ethernet (registered trademark), and Wi-Fi (registered trademark) communication methods. The USB communication method corresponds to a first communication method, which is a one-to-one communication method without using a network, according to the present disclosure. The Wi-Fi communication method corresponds to a second communication method, which is a communication method via a network, according to the present disclosure.

The printing device 1 includes a processor 10, a USB interface 20, an Ethernet interface 21, a Wi-Fi interface 22, a RAM 30, a flash ROM 31, and a touch panel-type display unit 40. The flash ROM 31 corresponds to a storage unit according to the present disclosure.

The printing device 1 is coupled to a personal computer (PC) 60 via the USB interface 20 or the Ethernet interface 21. The printing device 1 is coupled to the PC via a USB cable 61. The printing device 1 is connected to the PC 60 and a mobile terminal 70 by wireless communication via a router 50, using the Wi-Fi interface 22. The mobile terminal 70 is, for example, a smartphone, a tablet terminal, a mobile phone or the like. The PC 60 corresponds to a first communication terminal according to the present disclosure, and the mobile terminal 70 corresponds to a second terminal device according to the present disclosure.

The router 50 is connected to a network 100, and the PC 60 and the mobile terminal 70 communicate with a maintenance server 110 connected to the network 100, via the router 50. The maintenance server 110 provides update data of software such as firmware used in the printing device 1.

The printing device 1 includes the processor 10, the RAM 30, the flash ROM 31, and the touch panel-type display unit 40. The RAM 30 is a rewritable volatile memory, and the flash ROM 31 is a rewritable nonvolatile memory.

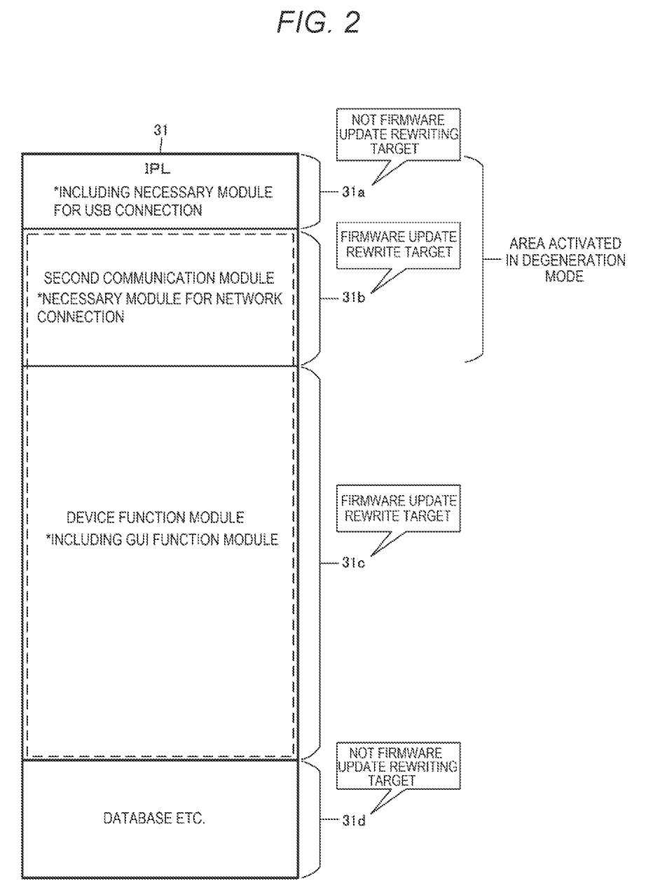

FIG. 2 illustrates the mapping of the flash ROM 31. As illustrated in FIG. 2, the flash ROM 31 is divided into a first area 31a, a second area 31b, a third area 31c, and a fourth area 31d as storage areas for firmware. The first area 31a is mapped as a storage area for an initial program loader (IPL), and the second area 31b is mapped as a storage area for a second communication module. The IPL includes a module necessary for USB communication, and the second communication module includes a module necessary for Wi-Fi communication.

The third area 31c is mapped as a storage area for a device function module, and the fourth area 31d is mapped as a storage area for a database or the like. The device function module includes a graphical user interface (GUI) function module via the display unit 40. The third area 31c, where the device function module is saved, is larger than the second area 31b, where the second communication module is saved. Rewriting of saved data by update processing of firmware, described later, is executed for the second area 31b and the third area 31c, among the first to fourth areas 31a to 31d, and in the order from the second area 31b to the third area 31c.

The processor 10 reads and executes the IPL from the flash ROM 31 and thus functions as a communication control unit 11, a firmware update unit 12, a situation recognition unit 13, an update retry control unit 14, and an abnormal termination notification unit 15.

The communication control unit 11 executes communication control by USB, Ethernet, and Wi-Fi. The communication control unit 11 supports only the USB communication when the IPL is executed, and the communication control unit 11 is enabled to support the Ethernet communication and the Wi-Fi communication by executing the second communication module.

The firmware update unit 12 executes update processing of the firmware saved in the flash ROM 31 in response to an operation of the PC 60 or the mobile terminal 70 by a user U of the printing device 1. In the PC 60 and the mobile terminal 70, a use application (application program) of the printing device 1 is installed, and the user U operates the use application to give an instruction to update the firmware.

The use application accesses the maintenance server 110 via the network 100 in response to the instruction to update the firmware, downloads a firmware update program from the maintenance server 110, and transmits the firmware update program to the printing device 1. The firmware update unit 12 saves the update program received from the PC 60 or the mobile terminal 70 in the RAM 30, executes the update program saved in the RAM 30, and rewrites the data saved in the second area 31b and the third area 31c of the flash ROM 31.

The situation recognition unit 13 recognizes a situation where an abnormal termination has occurred (abnormal termination situation) when the update processing of the firmware is interrupted due to the power shutdown of the printing device 1 (due to disconnection of the power plug from the outlet, power failure, or the like) and the update processing is abnormally terminated. Due to the power shutdown, the update program saved in the RAM 30 disappears and the update processing of the firmware cannot be continued. Therefore, the firmware update program needs to be transmitted again from the PC 60 or the mobile terminal 70 to the printing device 1.

The update retry control unit 14 switches the control of the retry of the update processing of the firmware according to the abnormal termination situation. The abnormal termination notification unit 15 displays an abnormality notification on the display unit 40 when an abnormal termination occurs.

### 2. Update Processing of Firmware

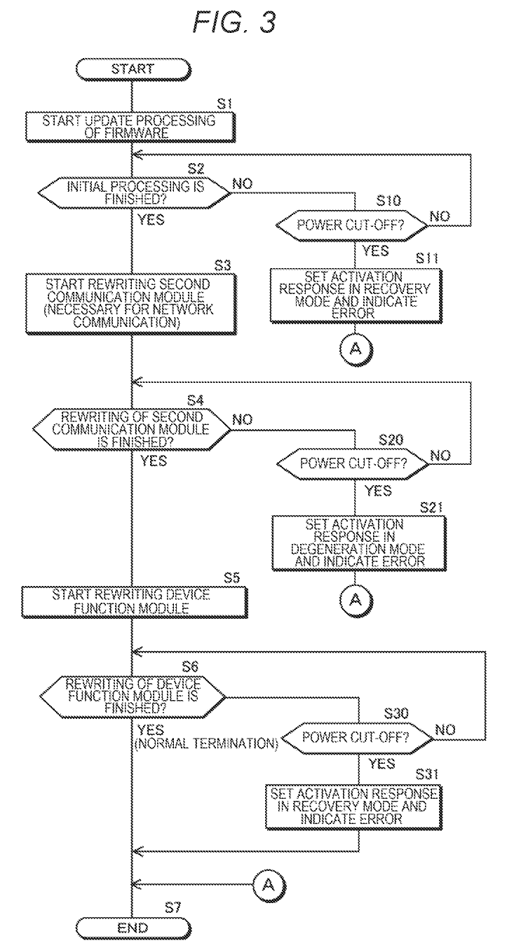

The procedure of update processing of the firmware executed by the firmware update unit 12, the situation recognition unit 13, and the update retry control unit 14 will be described with reference to the flowchart illustrated in FIG. 3.

In step S1 in FIG. 3, the firmware update unit 12 starts the update processing of the firmware saved in the flash ROM 31. As described above, the firmware update unit 12 rewrites the data of the second communication module saved in the second area 31b of the flash ROM 31 and the data of the device function module saved in the third area 31c by the update processing.

In the subsequent loop of steps S2 and S10, the situation recognition unit 13 determines in step S2 whether initial processing (such as error check of the update program saved in the RAM 30) by the firmware update unit 12 is finished. In step S10, the situation recognition unit 13 determines whether a power shutdown occurs. When the initial processing is finished, the situation recognition unit 13 advances the processing from step S2 to step S3. When a power shutdown occurs, the situation recognition unit 13 advances the processing from step S10 to step S11.

In step S11, the update retry control unit 14 sets an activation response in a recovery mode as the setting of the retry of the update processing of the firmware in response to the abnormal termination. In step S10, when a power shutdown occurs, since the rewriting of the second communication module is not started, the data of the second communication module is not broken (a second abnormal termination state according to the present disclosure), and the Wi-Fi communication using the second communication module is enabled.

Therefore, the update retry control unit 14 sets the activation response in the recovery mode for performing the update processing of the firmware by the Wi-Fi communication or the USB communication, and advances the processing to step S7. The abnormal termination notification unit 15 displays, on the display unit 40, an error code indicating that the update processing of the firmware is abnormally terminated and that the update processing of the firmware in the recovery mode can be retried. Instead of the error code or along with the error code, a text message indicating that the update processing of the firmware can be retried in the recovery mode may be displayed.

Thus, the retry of the update processing of the firmware using Wi-Fi and USB is allowed. In the recovery mode, the user U can connect the mobile terminal 70 and the printing device 1 by Wi-Fi and retry the update processing of the firmware. Therefore, a situation where the user U cannot prepare the USB-connectable PC 60 or the USB connection cable 61 and therefore cannot retry the update processing of the firmware can be prevented.

In step S3, the firmware update unit 12 starts rewriting the second communication module. In the subsequent loop processing of steps S4 and S20, the situation recognition unit 13 determines in step S4 whether the rewriting of the second communication module by the firmware update unit 12 is finished. In step S20, the situation recognition unit 13 determines whether a power shutdown occurs. When the rewriting of the second communication module is finished, the situation recognition unit 13 advances the processing from step S4 to step S5. When a power shutdown occurs, the situation recognition unit 13 advances the processing from step S20 to step S21.

In step S21, the update retry control unit 14 sets an activation response in a degeneration mode as the setting of the retry of the update processing of the firmware in response to the abnormal termination. When a power shutdown occurs in step S20, the data of the second communication module is broken (a first situation according to the present disclosure) due to the power shutdown during the rewriting of the second communication module, and the Wi-Fi communication is disabled.

Therefore, the update retry control unit 14 allows the update processing of the firmware by USB communication, sets the activation response in the degeneration mode, in which the update processing of the firmware by Wi-Fi is prohibited, and advances the processing to step S7. The abnormal termination notification unit 15 displays, on the display unit 40, an error code indicating that the update processing of the firmware is abnormally terminated and that the update processing of the firmware in the degeneration mode can be retried. Instead of the error code or along with the error code, a text message indicating that the update processing of the firmware can be retried in the degeneration mode may be displayed.

In the degeneration mode, since the user U cannot connect the mobile terminal 70 to the printing device 1 by the Wi-Fi communication, the user U needs to prepare the PC 60, connect the PC 60 and the printing device 1 by the USB communication, and retry the update processing of the firmware. Alternatively, the user U needs to take or send the printing device 1 to a service center or the like and thus request completion work of the update processing of the firmware.

In step S5, the firmware update unit 12 starts rewriting the device function module. In the subsequent loop processing of steps S6 and S30, the situation recognition unit 13 determines in step S6 whether the rewriting of the device function module by the firmware update unit 12 is finished. In step S30, the situation recognition unit 13 determines whether a power shutdown occurs. When the rewriting of the device function module is finished, the situation recognition unit 13 advances the processing from step S6 to step S7 (a state where the update processing of the firmware is normally finished). When a power shutdown occurs, the situation recognition unit 13 advances the processing from step S30 to step S31.

In step S31, the update retry control unit 14 sets an activation response in the recovery mode as the setting of the retry of the update processing of the firmware in response to the abnormal termination. In step S30, when a power shutdown occurs, since the rewriting of the second communication module is already been finished, the data of the second communication module is not broken (the second abnormal termination state according to the present disclosure). Therefore, the Wi-Fi communication using the second communication module is enabled.

Therefore, the update retry control unit 14 sets the activation response in the recovery mode for performing the update processing of the firmware by the Wi-Fi or USB communication, and advances the processing to step S7. Also, as in step S11, the abnormal termination notification unit 15 displays, on the display unit 40, an error code or the like indicating that the update processing of the firmware is abnormally terminated and that the update processing of the firmware in the recovery mode can be retried.

### 3. Other Embodiments

In the above embodiment, the printing device 1 is disclosed as the electronic device according to the present disclosure. The electronic device according to the present disclosure may be any electronic device that executes update processing of firmware by communication, and may be, for example, a scanner, a projector, or the like.

In the above embodiment, the USB is used as an example of the one-to-one first communication method without using a network according to the present disclosure, but the first communication method may be another communication method such as Bluetooth (registered trademark).

In the above embodiment, as an example of the first situation according to the present disclosure, the case where the update processing of the firmware is abnormally terminated due to the power shutdown during the rewriting of the second communication module is described. As an example of the second situation according to the present disclosure, the case where the update processing of the firmware is abnormally terminated due to the power shutdown before the rewriting of the second communication module is started or after the rewriting of the second communication module is finished is described. As other embodiments, the first situation and the second situation may be defined as in Examples 1 to 3 described below. The update retry control unit 14 sets the activation in the degeneration mode for the first situation, and sets the activation in the recovery mode for the second situation.

### Example 1

First situation: a situation where the abnormal termination of the update processing occurs after a first predetermined time elapses from a time point when the update processing of the firmware is started and before a second predetermined time longer than the first predetermined time elapses from the time point when the update processing is started.

Second situation: a situation where the abnormal termination of the update processing occurs before the first predetermined time elapses from the time point when the update processing of the firmware is started or after the second predetermined time elapses from the time point when the update processing is started.

The first predetermined time is set by assuming the time from the time when the update processing of the firmware is started in step S1 in FIG. 3 to the time when the rewriting of the second communication module is started in step S3. In addition, the second predetermined time is set by assuming the time from the time when the update processing of the firmware is started in step S1 in FIG. 3 to the time when the rewriting of the second communication module is finished in step S4.

### Example 2

First situation: a situation where the abnormal termination of the update processing occurs after processing for a first predetermined amount of data, of the update processing, is finished after the update processing of the firmware is started, and before processing for a second predetermined amount of data, of the update processing, is finished after the update processing is started. The second predetermined amount of data is larger than the first predetermined amount of data.

Second situation: a situation where the abnormal termination of the update processing occurs before the processing for the first predetermined amount of data, of the update processing, is finished after the update processing of the firmware is started, or after the processing for the second predetermined amount of data, of the update processing, is finished after the update processing is started.

The first predetermined amount of data is set by assuming the amount of data in the update processing of the firmware that is processed from the start of the update processing of the firmware in step S1 in FIG. 3 to the start of the rewriting of the second communication module in step S3. The second predetermined amount of data is set by assuming the amount of data in the update processing of the firmware that is processed from the start of the update processing of the firmware in step S1 in FIG. 3 to the end of the rewriting of the second communication module in step S4.

### Example 3

First situation: a situation where the abnormal termination of the update processing occurs after processing for a first predetermined ratio, of the update processing, is finished after the update processing of the firmware is started, and before processing for a second predetermined ratio, of the update processing, is finished after the update processing is started. The second predetermined ratio is higher than the first predetermined ratio.

Second situation: a situation where the abnormal termination of the update processing occurs before processing for the first predetermined ratio, of the update processing, is finished after the update processing of the firmware is started, or after processing for the second predetermined ratio, of the update processing, is finished after the update processing is started.

The first predetermined ratio is set by assuming the ratio of the amount of processing from the start of the update processing of the firmware in step S1 in FIG. 3 to the start of the rewriting of the second communication module in step S3 to the total amount of processing of the update processing of the firmware. The second predetermined ratio is set by assuming the ratio of the amount of processing from the start of the update processing of the firmware in step S1 in FIG. 3 to the finish of the rewriting of the second communication module in step S4 to the total amount of processing of the update processing of the firmware.

### 4. Summary of Present Disclosure

The present disclosure is summarized below as appendices.

### Appendix 1

An electronic device includes: a firmware update unit configured to execute update processing of firmware saved in a storage unit, using update data acquired by performing communication with a first terminal device by a first communication method or by performing communication with a second terminal device by a second communication method; a situation recognition unit configured to recognize, when an abnormal termination of the update processing occurs, an abnormal termination situation, which is a situation of when the abnormal termination occurs; and an update retry control unit configured to permit a retry of the update processing by performing communication with the first terminal device by the first communication method and prohibit a retry of the update processing by performing communication with the second terminal device by the second communication method, when the situation recognition unit recognizes that the abnormal termination situation is a first situation as the abnormal termination of the update processing occurs, and to permit a retry of the update processing by performing communication with the first terminal device by the first communication method and a retry of the update processing by performing communication with the second terminal device by the second communication method, when the situation recognition unit recognizes that the abnormal termination situation is a second situation different from the first situation.

Thus, when an abnormal termination of the update processing of the firmware occurs, in the second situation, the firmware can be updated using the terminal device that can perform communication by one of the first communication method and the second communication method. Therefore, a situation where a terminal device that supports the first communication method cannot be prepared and the update processing of the firmware cannot be retried, can be prevented.

### Appendix 2

In the electronic device according to Appendix 1, the first situation is a situation where the abnormal termination occurs after a first predetermined time elapses from a time point when the update processing is started and before a second predetermined time longer than the first predetermined time elapses from the time point when the update processing is started, and the second situation is a situation where the abnormal termination occurs before the first predetermined time elapses from the time point when the update processing is started or after the second predetermined time elapses from the time point when the update processing is started.

Thus, whether the situation of when the abnormal termination occurs is the first situation or the second situation can be recognized according to the elapsed time from the time point when the update processing of the firmware is started to the time point when the abnormal termination occurs.

### Appendix 3

In the electronic device according to Appendix 1, the first situation is a situation where the abnormal termination occurs after processing for a first predetermined amount of data, of the update processing, is finished after the update processing is started, and before processing for a second predetermined amount of data larger than the first predetermined amount of data, of the update processing, is finished after the update processing is started, and the second situation is a situation where the abnormal termination occurs before the processing for the first predetermined amount of data, of the update processing, is finished after the update processing is started, or after the processing for the second predetermined amount of data, of the update processing is finished after the update processing is started.

Thus, whether the situation of when the abnormal termination occurs is the first situation or the second situation can be recognized according to the amount of data processing in the update processing until the abnormal termination occurs after the update processing of the firmware is started.

### Appendix 4

In the electronic device according to Appendix 1, the first situation is a situation where the abnormal termination occurs after processing for a first predetermined ratio, of a total amount of processing of the update processing, is finished after the update processing is started, and before processing for a second predetermined ratio higher than the first predetermined ratio, of the update processing, is finished after the update processing is started, and the second situation is a situation where the abnormal termination occurs before the processing for the first predetermined ratio, of the update processing, is finished after the update processing is started, or after the processing for the second predetermined ratio, of the update processing, is finished after the update processing is started.

Thus, whether the situation of when the abnormal termination occurs is the first situation or the second situation can be recognized according to the status of progress of the update processing until the abnormal termination occurs after the update processing of the firmware is started.

### Appendix 5

In the electronic device according to any one of Appendices 1 to 4, the firmware includes a first communication module for executing communication by the first communication method, a second communication module for executing communication by the second communication method, and a device function module for executing a predetermined function of the electronic device, and the firmware update unit executes the update processing for the second communication module and the device function module, and executes processing of updating the device function module after executing processing of updating the second communication module.

Thus, the processing of updating the second communication module is performed before the processing of updating the device function module, and a situation where the abnormal termination of the update processing occurs during the update of the second communication module and disables the communication using the second communication method can be suppressed.

### Appendix 6

In the electronic device according to Appendix 1, the firmware includes a first communication module for executing communication by the first communication method, a second communication module for executing communication by the second communication method, and a device function module for executing a predetermined function of the electronic device, the firmware update unit executes the update processing for the second communication module and the device function module, the first situation is a situation where the abnormal termination occurs while processing of updating the second communication module is being executed in the update processing, and the second situation is a situation where the abnormal termination occurs before the processing of updating the second communication module is started or after the processing of updating the second communication module is finished in the update processing.

Thus, a situation where the communication by the second communication method is enabled since the abnormal termination of the update processing occurs before the processing of updating the second communication module is executed or after the processing of updating the second communication module is executed, can be set as the second situation.

### Appendix 7

In the electronic device according to Appendix 6, the firmware update unit executes processing of updating the device function module after executing the processing of updating the second communication module in the update processing.

Thus, the processing of updating the second communication module is performed before the processing of updating the device function module, and a situation where the abnormal termination of the update processing occurs during the update of the second communication module and disables the communication using the second communication method can be suppressed.

### Appendix 8

In the electronic device according to any one of Appendices 1 to 7, the first communication method is a one-to-one communication method without using a network.

Thus, regardless of whether the situation where the update processing is abnormally terminated is the first situation or the second situation, the retry of the update processing can be executed by performing the communication with the first terminal device using the one-to-one first communication method.

### Appendix 9

In the electronic device according to any one of Appendices 1 to 8, the second communication method is a communication method via a network.

Thus, when the situation where the update processing is abnormally terminated is the second situation, the retry of the update processing can be executed by performing the communication with the second terminal device via a network using the second communication method.

### Appendix 10

The electronic device according to any one of Appendices 1 to 9 includes an abnormal termination notification unit configured to cause a display unit provided in the electronic device to display that it is the first situation and that it is the second situation, in different display modes.

Thus, the user of the electronic device can be notified of whether the situation when the abnormal termination of the update processing occurs is the first situation or the second situation in a distinguishable manner.

### Appendix 11

In the electronic device according to any one of Appendices 1 to 10, the electronic device is a printing device including a display unit, the storage unit is a rewritable nonvolatile memory, the firmware includes a first communication module for executing communication by the first communication method, a second communication module for executing communication by the second communication method, and a device function module for executing a predetermined function of the electronic device, the firmware update unit executes the update processing for the second communication module and the device function module, and the predetermined function includes at least a function of a graphical user interface (GUI) displayed on the display unit.

Thus, for the electronic device, which is a printing device, when the update processing is abnormally terminated at the time of updating the firmware including the GUI function module, a situation where the execution of the retry of the update processing by performing the communication by the second communication method is disabled can be suppressed.

### Appendix 12

In the electronic device according to Appendix 11, in the storage unit, an area occupied by the device function module is larger than an area occupied by the second communication module, and the firmware update unit executes processing of updating the device function module after executing processing of updating the second communication module in the update processing.

Thus, the second communication module having a smaller amount of data than the device function module is updated before the device function module, and a situation where the abnormal termination of the update processing occurs during the update of the second communication module and disables the communication using the second communication method can be suppressed.

What is claimed is:

1. An electronic device comprising:
a firmware update unit configured to execute update processing of firmware saved in a storage unit, using update data acquired by performing communication with a first terminal device by a first communication method or by performing communication with a second terminal device by a second communication method;
a situation recognition unit configured to recognize, when an abnormal termination of the update processing occurs, an abnormal termination situation, which is a situation of when the abnormal termination occurs; and
an update retry control unit configured to permit a retry of the update processing by performing communication with the first terminal device by the first communication method and prohibit a retry of the update processing by performing communication with the second terminal device by the second communication method, when the situation recognition unit recognizes that the abnormal termination situation is a first situation as the abnormal termination of the update processing occurs, and to permit a retry of the update processing by performing communication with the first terminal device by the first communication method and a retry of the update processing by performing communication with the second terminal device by the second communication method, when the situation recognition unit recognizes that the abnormal termination situation is a second situation different from the first situation.

2. The electronic device according to claim 1, wherein
the first situation is a situation where the abnormal termination occurs after a first predetermined time elapses from a time point when the update processing is started and before a second predetermined time longer than the first predetermined time elapses from the time point when the update processing is started, and
the second situation is a situation where the abnormal termination occurs before the first predetermined time elapses from the time point when the update processing is started or after the second predetermined time elapses from the time point when the update processing is started.

3. The electronic device according to claim 1, wherein
the first situation is a situation where the abnormal termination occurs after processing for a first predetermined amount of data, of the update processing, is finished after the update processing is started, and before processing for a second predetermined amount of data larger than the first predetermined amount of data, of the update processing, is finished after the update processing is started, and
the second situation is a situation where the abnormal termination occurs before the processing for the first predetermined amount of data, of the update processing, is finished after the update processing is started, or after the processing for the second predetermined amount of data, of the update processing is finished after the update processing is started.

4. The electronic device according to claim 1, wherein
the first situation is a situation where the abnormal termination occurs after processing for a first predetermined ratio, of a total amount of processing of the update processing, is finished after the update processing is started, and before processing for a second predetermined ratio higher than the first predetermined ratio, of the update processing, is finished after the update processing is started, and
the second situation is a situation where the abnormal termination occurs before the processing for the first predetermined ratio, of the update processing, is finished after the update processing is started, or after the processing for the second predetermined ratio, of the update processing, is finished after the update processing is started.

5. The electronic device according to claim 1, wherein
the firmware includes a first communication module for executing communication by the first communication method, a second communication module for executing communication by the second communication method, and a device function module for executing a predetermined function of the electronic device, and
the firmware update unit executes the update processing for the second communication module and the device function module, and executes processing of updating the device function module after executing processing of updating the second communication module.

6. The electronic device according to claim 1, wherein
the firmware includes a first communication module for executing communication by the first communication method, a second communication module for executing communication by the second communication method, and a device function module for executing a predetermined function of the electronic device,
the firmware update unit executes the update processing for the second communication module and the device function module,
the first situation is a situation where the abnormal termination occurs while processing of updating the second communication module is being executed in the update processing, and
the second situation is a situation where the abnormal termination occurs before the processing of updating the second communication module is started or after the processing of updating the second communication module is finished in the update processing.

7. The electronic device according to claim 6, wherein
the firmware update unit executes processing of updating the device function module after executing the processing of updating the second communication module in the update processing.

8. The electronic device according to claim 1, wherein
the first communication method is a one-to-one communication method without using a network.

9. The electronic device according to claim 1, wherein
the second communication method is a communication method via a network.

10. The electronic device according to claim 1, comprising:
an abnormal termination notification unit configured to cause a display unit provided in the electronic device to display that it is the first situation and that it is the second situation, in different display modes.

11. The electronic device according to claim 1, wherein
the electronic device is a printing device including a display unit,
the storage unit is a rewritable nonvolatile memory,
the firmware includes a first communication module for executing communication by the first communication method, a second communication module for executing communication by the second communication method, and a device function module for executing a predetermined function of the electronic device,
the firmware update unit executes the update processing for the second communication module and the device function module, and
the predetermined function includes at least a function of a graphical user interface (GUI) displayed on the display unit.

12. The electronic device according to claim 11, wherein
in the storage unit, an area occupied by the device function module is larger than an area occupied by the second communication module, and
the firmware update unit executes processing of updating the device function module after executing processing of updating the second communication module in the update processing.
